(19) United States
(12) Patent Application Publication
(10) Pub. No.: US 2015/0378015 A1
(43) Pub. Date: Dec. 31, 2015

(54) APPARATUS AND METHOD FOR SELF-LOCALIZATION OF VEHICLE

(71) Applicant: HYUNDAI MOTOR COMPANY, Seoul (KR)

(72) Inventors: Byung Yong YOU, Suwon-si (KR); Myung Seon Heo, Seoul (KR); Young Chul Oh, Seongnam-si (KR)

(73) Assignee: HYUNDAI MOTOR COMPANY

(21) Appl. No.: 14/525,141

(22) Filed: Oct. 27, 2014

(30) Foreign Application Priority Data
Jun. 30, 2014 (KR) 10-2014-0081139

(51) Int. Cl. G01S 13/06; G01S 19/13; G01S 13/86

(52) U.S. Cl. CPC G01S 13/06; G01S 13/867; G01S 19/13

(57) ABSTRACT

An apparatus for a self localization of a vehicle includes a sensor unit, a landmark detector, a landmark recognizer, and a location estimator. The sensor includes at least two sensors and is configured to measure information on environment around the vehicle using each of the at least two sensors. The landmark detector is configured to detect landmark information based on data measured by each sensor. The landmark recognizer is configured to selectively combine landmark information detected based on data measurement of at least one of the at least two sensors to recognize a landmark and reflect fused landmark information to update a probability distribution. The location estimator is configured to use the probability distribution updated by the landmark recognizer to estimate a self location of the vehicle.

### CROSS-REFERENCE TO RELATED APPLICATION

This application is based on and claims the benefit of priority to Korean Patent Application No. 10-2014-0081139, filed on Jun. 30, 2014 in the Korean Intellectual Property Office, the entire content of which is incorporated herein in its entirety by reference.

### TECHNICAL FIELD

The present disclosure relates to an apparatus and a method for a self localization of vehicle, and more particularly, to an apparatus and a method for a self localization of vehicle capable of detecting landmark information using a camera and a radar and selectively fusing the detected landmark information to precisely recognize a self vehicle location, the location of the current vehicle.

### BACKGROUND

With the increasing interest in an autonomous vehicle, a localization method capable of precisely estimating a self vehicle location at a downtown area becomes more important. The autonomous vehicle is driven based on a precise map. However, if a driver of a vehicle does not know where the current vehicle is located on a precise map, the precise map is of no avail. Recently, there has been much research conducted on positioning by scanning map environment using a two-dimensional (2D)/three-dimensional light detection and ranging (LiDAR) having very high range precision and then comparing currently scanned data with landmark information based on information on the scanned map environment.

The related art uses a very expensive sensor such as a LiDAR sensor and therefore is less likely to be actually applied to a vehicle. Further, according to the related art, a method for measuring a vehicle location by comparing the scanned data with the landmark information has insufficient robustness at the time of a change in surrounding environment.

Further, the related art uses only one range sensor information and therefore is not suitable for using in a complex downtown environment.

### SUMMARY

The present disclosure has been made to solve the above-mentioned problems occurring in the prior art while advantages achieved by the prior art are maintained intact.

An aspect of the present disclosure provides an apparatus and a method for a self localization of vehicle capable of detecting landmark information using a camera and a radar and selectively fusing the detected landmark information to precisely recognize a self vehicle location.

One aspect of the present disclosure relates to an apparatus for a self localization of a vehicle includes a sensor unit, a landmark detector, a landmark recognizer and a location estimator. The sensor unit includes at least two sensors and is configured to measure information on environment around the vehicle using each of the at least two sensors. The landmark detector is configured to detect landmark information based on data measured by each sensor. The landmark recognizer is configured to selectively combine landmark information detected based on data measurement of at least one of the at least two sensors to recognize a landmark and reflect fused landmark information to update a probability distribution. The location estimator is configured to use the probability distribution updated by the landmark recognizer to estimate a self location of the vehicle.

The sensor unit may include an image photographer configured to photograph images around the vehicle, a wireless monitor configured to detect objects around the vehicle and measure a relative range and direction from the detected objects, and a satellite navigation receiver configured to receive location information of the vehicle.

The image photographer may be any one of a single camera, a stereoscopic camera, an omni-directional camera, and a multi-view camera.

The wireless monitor may include a radio detection and ranging (RADAR).

The landmark detector may include a first landmark detector configured to detect landmark information from the images around the vehicle, a second landmark detector configured to detect information on the landmark detected by the wireless monitor, and a third landmark detector configured to detect the location information as the landmark.

The landmark detector may use any one of a Kalman filter and a particle filter to fuse the detected landmark information.

The location estimator may use the updated probability distribution to estimate a location at which a current vehicle is most likely to be located as a self vehicle location.

The probability distribution may be a Gaussian probability distribution.

Another aspect of the present disclosure encompasses a method for a self localization of vehicle including measuring information on environment around the vehicle using at least one sensor. Landmark information is detected based on data measured by the sensors; recognizing a landmark by selectively combining landmark information detected based on data measurement of the at least one sensor. A probability distribution is updated by reflecting the recognized landmark. A self vehicle location is estimated using the updated probability distribution.

In the measuring of the information, surrounding environment information of the vehicle may be measured by a camera, a radar, and a global positioning system (GPS) receiver, respectively.

In the recognizing of the landmark, when a vehicle is located in a GPS shadow area, the landmark information detected by the camera and the radar may be fused to recognize the landmark.

In the detecting of the landmark information, candidate areas corresponding to each of the detected landmark information may be selected on a map data.

In the detecting of the landmark information, it may be detected whether an area is congested by measuring a moving speed of a current vehicle, and a chronically congested candidate area may be detected as the landmark information from a chronically congested area information database classified by time.

In the recognizing of the landmark, the detected landmark information may be fused using at least any one of a Kalman filter and a particle filter.

The probability distribution may be a Gaussian probability distribution.

In the estimating of the self vehicle location, a location at which the current vehicle is most likely to be located may be estimated as the self vehicle location.

### BRIEF DESCRIPTION OF THE DRAWINGS

The above and other objects, features and advantages of the present disclosure will be more apparent from the following detailed description taken in conjunction with the accompanying drawings.

FIG. 1 is a block configuration diagram illustrating an apparatus for a self localization of vehicle according to an exemplary embodiment of the present inventive concept.

FIG. 2 is a flow chart illustrating a method for a self localization of vehicle according to an exemplary embodiment of the present inventive concept.

FIGS. 3a to 3d are exemplified diagrams illustrating a probability distribution update according to an exemplary embodiment of the present inventive concept.

### DETAILED DESCRIPTION

Hereinafter, exemplary embodiments of the present inventive concept will be described in detail with reference to the accompanying drawings.

An exemplary embodiment of the present inventive concept may detect landmark information using sensors such as a camera and a radar and recognize a self location of a vehicle based on the detected landmark information. Here, the landmark means a distinguishable feature within the environment in which a vehicle is located.

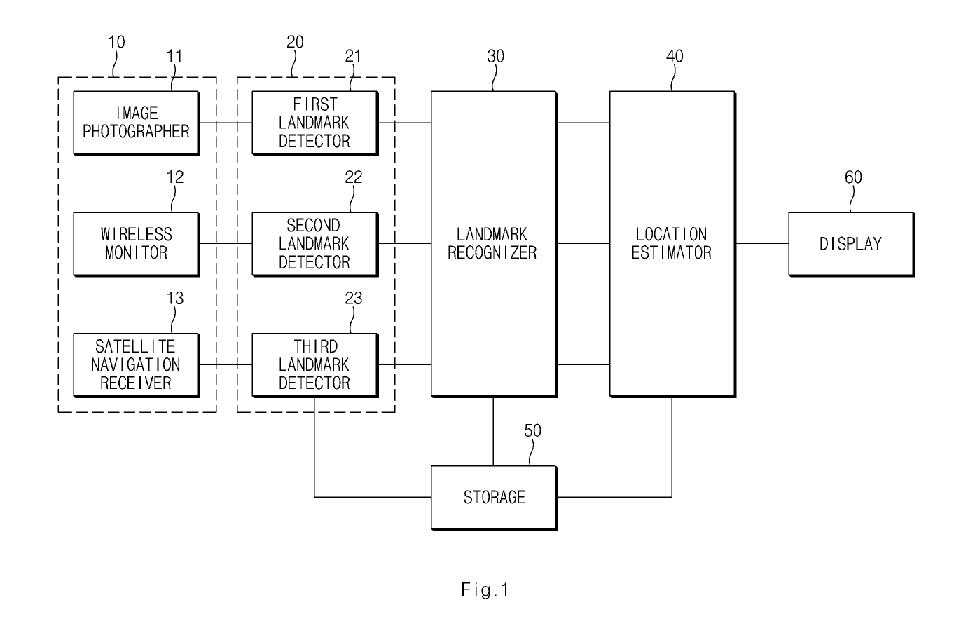

FIG. 1 is a block configuration diagram illustrating an apparatus for a self localization of vehicle according to an exemplary embodiment of the present inventive concept.

Referring to FIG. 1, an apparatus for a self localization of vehicle may include a sensor unit 10, a landmark detector 20, a landmark recognizer 30, a location estimator 40, a storage 50, a display 60, and the like.

The sensor unit 10 may include at least two sensors and may be configured to measure information on environment around a vehicle. The sensor unit 10 may include an image photographing unit 11, a wireless monitor 12, a satellite navigation receiver 13, and the like.

The image photographer 11 may photograph images (e.g., front image, rear image, side images, and the like) around a vehicle. In this case, the image photographer 11 may be implemented as a single camera, a stereoscopic camera, an omni-directional camera, a multi-view camera, and the like.

The wireless monitor 12 may transmit an electromagnetic wave and receive an echo signal returning by being reflected from an object to measure information of a range or distance up to the object, an altitude, an orientation, a speed, and the like. The wireless monitor 12 may be implemented as a radio detection and ranging (RADAR) which uses characteristics of a radio wave to detect an object (e.g., a shape of the object) and measure a relative range and direction. That is, the wireless monitor 12 detects landmarks (objects) located around a vehicle and measures the relative range and direction.

The satellite navigation receiver 13 may be a global positioning system (GPS) receiver which receives navigation information broadcast from a satellite. The satellite navigation receiver 13 may use navigation information (e.g., GPS information, GPS signal) to be able to confirm a current location (e.g., ground truth) of a vehicle, the total number of satellites capable of receiving satellite signals, the number of satellites capable of receiving a signal in a line of sight (LOS), a current vehicle speed, a multipath degree of a GPS signal in candidate areas, and the like.

The landmark detector 20 may include a first landmark detector 21, a second landmark detector 22, and a third landmark detector 23.

The first landmark detector 21 may process the image information photographed by the image photographer 11 to detect the landmark information. Here, the first landmark detector 21 may extract landmarks such as a front lane curvature included in the image information, left and right lane types (e.g., solid line, dotted line, and the like), left and right lane colors, a total number of lanes, a pedestrian crossing, a speed bump, and a speed sign and detect information on the extracted landmarks. For example, the first landmark detector 21 may detect the landmark information, for example, ‘there is a pedestrian crossing in front of 20 m from the current vehicle’. In this case, the first landmark detector 21 may select candidates on a map data based on the information (e.g., landmark information) on the detected landmark.

The second landmark detector 22 may detect the landmark information based on data measured by the wireless monitor 12. That is, the second landmark detector 22 may detect, as the landmark information, information such as a lane topography object adjacent to a road, a final lane parking and stopping vehicle, a median strip, and surrounding vehicle information. For example, the second landmark detector 22 detects the landmark information, for example, ‘the current vehicle is driving on a first lane of three lanes’. In this case, the second landmark detector 22 may select candidates on the map data based on the detected landmark information.

The third landmark detector 23 may detect, as the landmark information, positional information of a vehicle included in the navigation information (e.g., GPS information, GPS signal) received through the satellite navigation receiver 13. Further, the third landmark detector 23 may detect candidates, e.g., candidate areas, based on the detected landmark information. In other words, when received sensitivity of the GPS information is good or poor, the third landmark detector 23 may detect a radius as candidates, e.g., candidate areas, based on the positional information included in the GPS information. In this case, when the GPS signal cannot be received, the third landmark detector 23 may detect an area in which the GPS signal cannot be received as candidates on the map data.

The landmark recognizer 30 may selectively combine (or fuse) at least one of the landmark information detected by each landmark detector 21 to 23 to recognize the landmark. In this case, the landmark recognizer 30 may fuse (or integrate) the landmark information detected by a filter such as a Kalman filter and/or a particle filter to recognize the landmark.

In other words, the landmark recognizer 30 may combine at least one of the measurement data outputted from the image photographer 11, the wireless monitor 12, and the satellite navigation receiver 13 with the map data to recognize the landmark.

Further, the landmark recognizer 30 may reflect the information on the recognized landmark to update a probability distribution to estimate a location at which a vehicle is most likely to be located as a self position. In this case, as the probability distribution, various known probability distributions such as a Gaussian probability distribution may be applied.

When a new landmark is present, the landmark recognizer 30 may update the probability distribution based on a measurement value for the new landmark by the sensor. On the other hand, when a new landmark is not present, the landmark recognizer 30 may model a target (e.g., landmark) to be obtained to update the probability distribution.

The location estimator 40 may use the updated probability distribution to estimate a location at which a vehicle is most likely to be located as a self position.

The storage 50 may store various types of data such as the map data, the probability distribution (e.g., a probability distribution function), and the information on the landmark (e.g., landmark information). Various types of data may be databased and stored. The storage 50 may be implemented as an optical memory, a random access memory (RAM), a dynamic RAM (DRAM), a universal serial bus (USB) memory, a solid state drive (SSD), a read only memory (ROM), and the like.

The display 60 may display the self location of the vehicle estimated by the location estimator 40 on the map data. As the display 60, a display for a navigation terminal may be used or the display 60 may also be implemented as a separate display device. For example, the display 60 may be implemented as a liquid crystal display, a transparent display, a light emitting diode (LED) display, a touch screen, and the like.

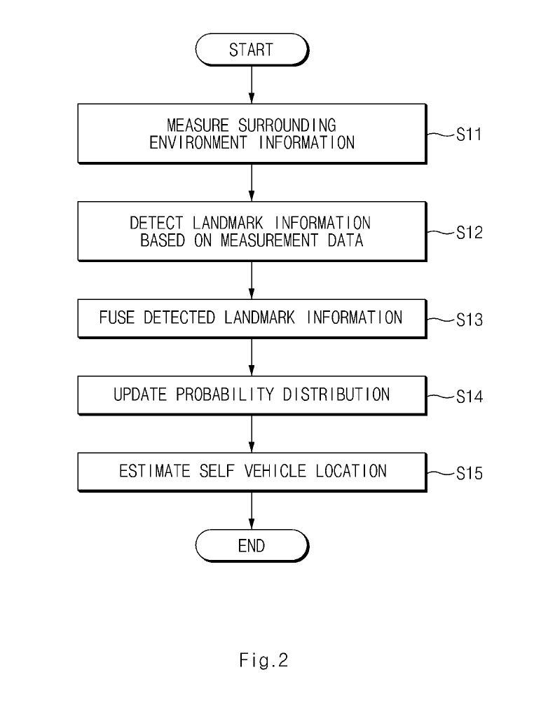

FIG. 2 is a flow chart illustrating a method for a self localization of vehicle according to an exemplary embodiment of the present inventive concept.

Referring to FIG. 2, the apparatus for a self localization of vehicle may measure the information on the environment around the vehicle by at least one sensor configuring the sensor unit 10 (S11). That is, the image photographer 11 may photograph the images around the vehicle, the wireless monitor 12 may detect objects (e.g., landmarks) around the vehicle and measure the relative range and direction, and the satellite navigation receiver 13 may receive the navigation information (e.g., GPS information) from the satellite.

The landmark detector 20 may detect the landmark information based on the data measured by at least one sensor (S12). Here, the landmark information may include the information on the landmarks such as the front lane curvature, the left and right lane types (e.g., solid line, dotted line, and the like), the left and right lane colors, the pedestrian crossing, the speed bump, the speed sign, the topography objects (e.g., street tress, barrier, and the like), the median strip, the surrounding vehicle information (e.g., reverse vehicle, forward vehicle, and the like), and the final lane parking and stopping vehicle.

The first landmark detector 21 may extract the landmarks from the surrounding images photographed by the image photographer 11 and detect the information on the extracted landmarks. Further, the second landmark detector 22 may detect the information on the landmarks detected by the wireless monitor 12 and the third landmark detector 23 may detect the landmark information from the navigation information received by the satellite navigation receiver 13. In this case, the first to third landmark detectors 21, 22, and 23 may select candidates, e.g., candidate areas, at which the current vehicle is likely to be located on the map data based on the landmark information.

The landmark recognizer 30 may selectively combine (or fuse) at least one of the detected landmark information to recognize the landmark (S13). In this case, the landmark recognizer 30 may allocate weights to each of the detected landmarks and fuses at least one landmark information by the Kalman filter and/or the particle filter, and the like.

The landmark recognizer 30 may reflect the fused landmark information to update the probability distribution (S14). Here, as the probability distribution, the Gaussian probability distribution may be used but the present inventive concept is not limited thereto, and therefore various known probability distributions may be applied thereto.

The location estimator 40 may use the updated probability distribution to estimate the positional information of the current vehicle (S15). In other words, the location estimator 40 may estimate a location at which the current vehicle is likely to be located as the self vehicle location.

For example, it is assumed that at Gangnam Station, intersection No. 1 and intersection No. 2 are surrounded with buildings and thus the received sensitivity of the GPS signal is weak, two pedestrian crossings are present therebetween, and a road is a single three-lane. The landmark detector 20 may acquire the landmark information, e.g., ‘a location on one of the roads present between Gangnam Station intersection No. 1 and Gangnam Station intersection No. 2’ through the GPS receiver 13, may acquire landmark information, e.g., ‘there is a pedestrian crossing in front of 20 m ahead’ through the camera 11, and may acquire landmark information, e.g., ‘the current vehicle is driving on a first lane among a total of three lanes’ through the radar 12. Further, the landmark recognizer 30 may fuse the detected landmark information to recognize the landmark. Therefore, the location estimator 40 may estimate, based on the landmark information fused by the landmark recognizer 30, that the current vehicle is currently located 20 m from the back of any one of two pedestrian crossings which are between Gangnam Station intersection No. 1 and Gangnam Station intersection No. 2 and is driving on a first lane among three lanes.

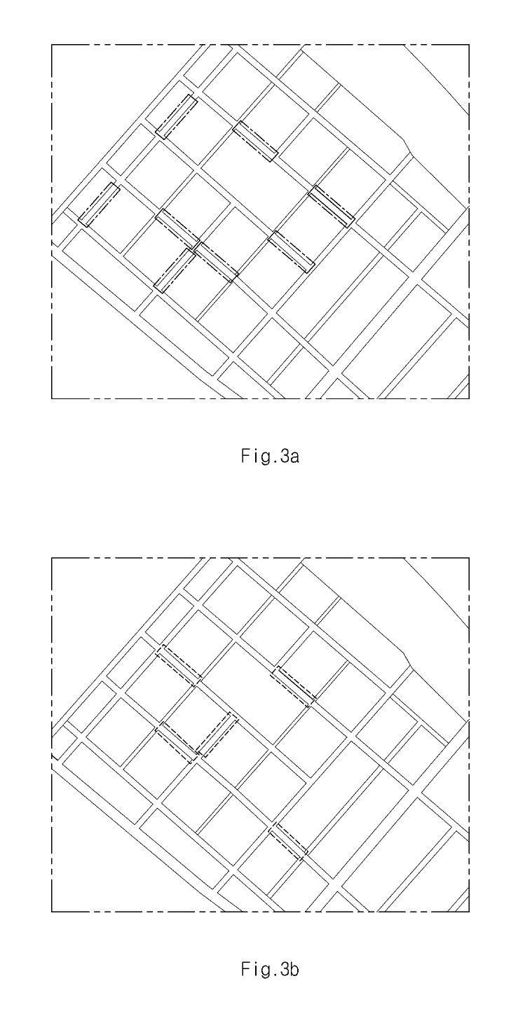

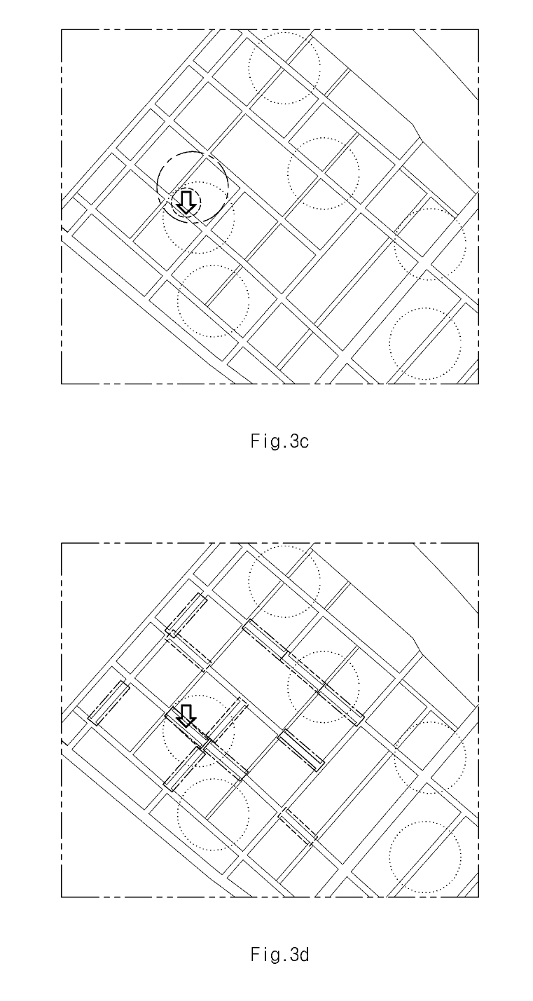

FIGS. 3a to 3d are exemplified diagrams illustrating a probability distribution update according to an exemplary embodiment of the present inventive concept.

First, the first landmark detector 21 may process the image information acquired by the image photographer 11 to extract the landmark. Further, the first landmark detector 21 may compare the extracted landmark with the landmark information included in the map data to select candidates, e.g., candidate areas, on the map data as illustrated in FIG. 3a.

The second landmark detector 22 may recognize the landmark located around the vehicle using the wireless monitor 12 to detect the recognized landmark information. Further, as illustrated in FIG. 3b, the second landmark detector 22 may select candidates, e.g., candidate areas, on the map data based on the detected landmark information.

Further, the third landmark detector 23 may detect, as the landmark information, the location information included in the navigation information received through the satellite navigation receiver 13. Further, as illustrated in FIG. 3c, the third landmark detector 23 may select the candidates (e.g., an area in which received sensitivity is good) based on the location information. Meanwhile, the third landmark detector 23 may select the area in which the received sensitivity is poor or no receiving area as candidates, e.g., candidate areas, when the received sensitivity of the GPS signal is poor or the GPS signal cannot be received.

The landmark recognizer 30 may fuse the landmark information outputted from the first to third landmark detectors 21 to 23 as illustrated in FIG. 3d and reflect the fused landmark information to update the probability distribution.

As described above, an exemplary embodiment of the present inventive concept may recognize the landmark based on the sensor fusion and may use the recognized landmark to estimate the self vehicle location. The apparatus for a self localization of vehicle according to an exemplary embodiment of the present inventive concept may generate the landmark map data along with the location estimation. In this case, the apparatus for a self localization of vehicle may perform coordinate synchronization of the image photographer 11 and the wireless monitor 12 and then generate the landmark map data using surrounding images photographed by the image photographer 11, a distance between objects around a vehicle measured by the wireless monitor 12 and the current vehicle, and the map data, and may store the generated landmark map data in the storage 50.

Further, an exemplary embodiment of the present inventive concept may recognize the landmark by matching at least one output data among data outputted from the image photographer 11, the wireless monitor 12, and the satellite navigation receiver 13, with the map data. The landmark detection according to different situations will be described below, by way of example.

First, when the landmark is detected by the coordinate synchronization of the image information and the radar information, the apparatus for a self localization of vehicle may match the surrounding images and the distance information acquired by the image photographer 11 and the wireless monitor 12 with the map data to recognize a guard rail as the landmark.

Second, when the road curvature information is used as the landmark, the apparatus for a self localization of vehicle may match the surrounding images photographed by the image photographer 11 with the road curvature information databased in the storage 50 to recognize the curvature information as the landmark. Next, the apparatus for a self localization of vehicle may match the curvature information with the map data to estimate the self vehicle location.

Third, when a bus number of local buses is used as the landmark, the apparatus for a self localization of vehicle may store path map data of at least one bus driving a target area, recognize a bus number driving around the current vehicle through the image photographer 11, and match the bus number with the path map data to estimate the self vehicle location.

Fourth, when a bus stop is used as the landmark, the apparatus for recognizing a self localization of vehicle may use the image photographer 11 to detect, as the landmark, a point (except for a pedestrian crossing), which is congested with people (for example: sidewalk), or a bus stop structure. Further, the apparatus for a self localization of vehicle may match the detected landmark information with the bus stop information of the map data to estimate the self vehicle location. In this case, as the plurality of bus information is acquired, the error range may be reduced.

Fifth, when using as the landmark a structure that cannot be detected as an image or detected by a radar, like a structure formed of a stone (for example, median strip), a structure which, the apparatus for a self localization of vehicle may detect the structure which may be detected by the image photographer 11 or may be detected by the wireless monitor 12 as the landmark. Further, the apparatus for a self localization of vehicle may match the detected landmark with the map data to estimate the self vehicle location.

Sixth, when the image photographer 11 and the satellite navigation receiver 13 are used, the apparatus for a self localization of vehicle may detect as the landmark a construction section (e.g., cone, protective wall, and the like) or feature structures such as a subway inlet structure, based on the image photographed by the image photographer 11. Further, the apparatus for a self localization of vehicle may extract the information on the extracted feature structures from the database and fuse the extracted information with the location information received through the satellite navigation receiver 13 to estimate the self vehicle location.

The above example discloses the detection of the landmark using the camera, the radar, and the GPS receiver, but the landmark may be detected by measuring the vehicle information. For example, when a chronically congested area is used as the landmark, the apparatus for a self localization of vehicle monitors moving speeds of the current vehicle and the surrounding vehicle using a vehicle wheel sensor and the wireless monitor 12 to confirm whether or not an area is congested. Further, when it is determined that the area is congested, the apparatus for a self localization of vehicle may detect, as the landmark information, chronically congested candidate areas from a chronically congested area information database classified by time and may estimate the self vehicle location by determining whether the vehicle is driving in the chronically congested area by fusing the detected landmark information with the landmark information detected by the satellite navigation receiver 13.

As described above, according to the exemplary embodiment of the present inventive concept, it is possible to estimate the self vehicle location by estimating the self vehicle location using the landmark information acquired through various types of sensors mounted in the vehicle and recognize the landmark using the camera and the radar even in the shadow area in which the GPS received sensitivity is low.

According to exemplary embodiments of the present inventive concept, it is possible to drive the autonomous vehicle in the areas (for example: shadow area, no receive area) in which the received sensitivity of the GPS signal is weak, by detecting the landmark information using the camera and the radar and fusing the detected landmark information to precisely recognize the self vehicle location.

Therefore, according to exemplary embodiments of the present inventive concept, it is possible to increase the reliability of the landmark due to the robust recognition information and increase the accuracy of the self localization (e.g., measurement) of vehicle under various situations using only the mass produced sensor for the vehicle.

What is claimed is:

1. An apparatus for a self localization of a vehicle, the apparatus comprising:
a sensor unit including at least two sensors and configured to measure information on environment around the vehicle using each of the at least two sensors;
a landmark detector configured to detect landmark information based on data measured by each sensor;
a landmark recognizer configured to selectively combine landmark information detected based on data measurement of at least one of the at least two sensors to recognize a landmark and reflect fused landmark information to update a probability distribution; and
a location estimator configured to use the probability distribution updated by the landmark recognizer to estimate a self location of the vehicle.

2. The apparatus according to claim 1, wherein the sensor unit includes:
an image photographer configured to photograph images around the vehicle;
a wireless monitor configured to detect objects around the vehicle and measure a relative range and direction from the detected objects; and
a satellite navigation receiver configured to receive location information of the vehicle.

3. The apparatus according to claim 2, wherein the image photographer is one selected from the group consisting of a single camera, a stereoscopic camera, an omni-directional camera, and a multi-view camera.

4. The apparatus according to claim 2, wherein the wireless monitor includes a radio detection and ranging (RADAR).

5. The apparatus according to claim 2, wherein the landmark detector includes:
a first landmark detector configured to detect landmark information from the images around the vehicle;
a second landmark detector configured to detect information on the landmark detected by the wireless monitor; and
a third landmark detector configured to detect the location information as the landmark.

6. The apparatus according to claim 1, wherein the landmark detector uses one selected from the group consisting of a Kalman filter and a particle filter to fuse the detected landmark information.

7. The apparatus according to claim 1, wherein the location estimator uses the updated probability distribution to estimate a location at which a current vehicle is most likely to be located as a self vehicle location.

8. The apparatus according to claim 1, wherein the probability distribution is a Gaussian probability distribution.

9. A method for a self localization of a vehicle, the method comprising:
measuring information on environment around the vehicle using at least one sensor;
detecting landmark information based on data measured by the at least one sensor;
recognizing a landmark by selectively combining landmark information detected based on data measurement of the at least one sensor;
updating a probability distribution by reflecting the recognized landmark; and
estimating a self vehicle location using the updated probability distribution.

10. The method according to claim 9, wherein the measuring of the information includes measuring surrounding environment information of the vehicle by a camera, a radar, and a global positioning system (GPS) receiver, respectively.

11. The method according to claim 10, wherein the recognizing of the landmark includes fusing, when a vehicle is located in a GPS shadow area, the landmark information detected by the camera and the radar to recognize the landmark.

12. The method according to claim 9, wherein the detecting of the landmark information includes selecting candidate areas corresponding to each of the detected landmark information on a map data.

13. The method according to claim 9, wherein the detecting of the landmark information includes detecting whether an area is congested by measuring a moving speed of a current vehicle and detecting a chronically congested candidate area as the landmark information from a chronically congested area information database classified by time.

14. The method according to claim 9, wherein the recognizing of the landmark includes fusing the detected landmark information by using at least one selected from the group consisting of a Kalman filter and a particle filter.

15. The method according to claim 9, wherein the probability distribution is a Gaussian probability distribution.

16. The method according to claim 9, wherein the estimating of the self vehicle location includes estimating, as the self vehicle location, a location at which the current vehicle is most likely to be located.
